(19) United States
(12) Patent Application Publication
(10) Pub. No.: US 2012/0044145 A1
(43) Pub. Date: Feb. 23, 2012

(54) SCROLL MOUSE WITH A SCREEN SCROLL FUNCTION

(76) Inventor: Youn Soo Kim, Seoul (KR)

(21) Appl. No.: 13/318,109

(22) PCT Filed: Apr. 28, 2010
(86) PCT No.: PCT/KR2010/002662

§ 371 Date: Oct. 28, 2011

(30) Foreign Application Priority Data
Apr. 29, 2009 (KR) 10-2009-0037774

(51) Int. Cl. G09G 5/08

(52) U.S. Cl. 345/163

(57) ABSTRACT

A scroll mouse that includes a housing; a mouse body arranged in the housing; pressure-sensing unit configured to sense the direction and magnitude of an external force applied to the mouse body, and generating a pointer movement signal or a screen scroll signal in the direction of the external force applied to the mouse body; and a press button which, when pressed by a user, switches the pressure-sensing means between a mode for generating the pointer movement signal and a mode for generating the screen scroll signal. The scroll mouse can move a pointer to a distance without significantly moving the mouse body, can freely scroll a screen in various directions, and can easily implement various operations such as dragging, line-drawing, etc.

### CROSS-REFERENCE TO RELATED APPLICATIONS

This application is a Section 371 national phase patent application of P.C.T. Application No. PCT/KR2010/002662, filed Apr. 28, 2010, which claims priority to Korean Patent Application No. 10-2009-0037774, filed Apr. 29, 2009, the entire contents both of which are hereby incorporation by reference.

### FIELD OF THE INVENTION

The present invention relates to a scroll mouse capable of scrolling a screen being displayed on a monitor, and more particularly, to a scroll mouse which can freely scroll a screen in various directions, and can move a pointer without moving a mouse body.

### BACKGROUND

A mouse is one of the representative input devices of a computer, along with a keyboard, and they are generally divided into serial and PS/2 mice according to the interface, and into a ball mouse, an optical mouse, and the like according to the manner of operation.

Such a conventional mouse is designed to move a pointer by being moved by a user in the horizontal direction. Thus, to move a pointer using the conventional mouse, space in which the mouse can move is essential. However, since the space for moving a mouse is not always sufficient, it may be insufficient and so a user may not be able to freely move a pointer. In addition, while the conventional mouse has been used for a long time when utilizing a computer, a user frequently suffers wrist pain because when the mouse is manipulated, a user's hand that holds the mouse unnaturally comes into contact with the frictional bottom or a pad over which the mouse slides, becoming tired.

In order to solve this problem, a fixed type mouse (Korean Application No.: 10-2007-44112) was proposed by the applicant, which is configured to enable a pointer to be moved either by a distance or continuously, without moving the mouse as such.

In the meantime, when a user utilizes a computer to perform a document processing task or an Internet search, he/she often has to read the text of a document that is long in the vertical direction. In this case, the user moves a screen to a certain position by clicking a vertical or horizontal movement bar of the currently available window, i.e. the active window, and dragging it to the certain position. However, such a function has a drawback in that the user has to press the selection button of the mouse for a long time, causing the user to become fatigued.

Thus, a mouse that is further equipped with a wheel key for easier scrolling of a screen has been commercialized. Here, the size of a conventional wheel key should be large enough for a user to turn the wheel key with his finger, so that it cannot problematically be adapted to a compact type mouse. Particularly, if the fixed type mouse proposed by the applicant is fabricated in a very small size such that it is manipulated by a user's finger, it is difficult to add such a wheel key to the fixed type mouse.

In addition, when performing a graphic-processing task, rather than surfing the Internet or performing a document processing task, horizontal scrolling is also frequently needed in addition to vertical scrolling. Thus, while many scroll devices capable of scrolling a screen in both the vertical and horizontal directions have been proposed, they have a complicated structure such that the size becomes larger than the wheel key, so that if they are made in a size compact enough for them to be manipulated with a user's finger, it is impossible to mount the wheel key thereto.

### SUMMARY

The present invention has been made to solve the foregoing problems with the related art, and therefore an aspect of the present invention is to provide a scroll mouse which can scroll a screen in various directions without repetitively turning a wheel key, and can move a pointer for a distance without moving a mouse body by very far.

According to an aspect of the present invention, a scroll mouse with a screen scroll function, includes: a housing; a mouse body arranged in the housing; and a pressure-sensing unit configured to sense a direction of an external force applied to the mouse body and to generate a screen scroll signal in the direction of the external force applied to the mouse body.

The pressure-sensing unit is configured to sense the direction and a magnitude of the external force applied to the mouse body, and if the magnitude of the external force applied to the mouse body is determined to be within one side of a predetermined value, and to generate a pointer movement signal, and if the magnitude of the external force applied to the mouse body is determined to fall on the other side of the predetermined value, and to generate the screen scroll signal in the direction of the external force applied to the mouse body.

The pressure-sensing unit is configured to sense the direction and a magnitude of the external force applied to the mouse body and to generate a pointer movement signal in the direction of the external force applied to the mouse body, and after the external force of the magnitude within a predetermined range has been applied to the mouse body with a predetermined frequency or for a predetermined length of time, and to generate the screen scroll signal in the direction of the external force applied to the mouse body.

The pressure-sensing unit is configured to repetitively switch between a mode for generating the pointer movement signal and a mode for generating the screen scroll signal, according to the frequency with which the external force of the magnitude within the predetermined range is applied to the mouse body within a predetermined time, or the length of time for which the external force of the magnitude within the predetermined range is applied to the mouse body.

The pressure-sensing unit is configured to repetitively switch between a mode for generating the pointer movement signal, a mode for generating the screen scroll signal, and a mode for generating a pointer movement signal in a state of being clicked, according to the frequency with which the external force of the magnitude within the predetermined range is applied to the mouse body within a predetermined time, or the length of time for which the external force of the magnitude within the predetermined range is applied to the mouse body.

The pressure-sensing unit is configured to sense the direction and magnitude of the external force applied to the mouse body and to generate a pointer movement signal or a screen scroll signal in the direction of the external force applied to the mouse body, and the scroll mouse further includes a push button configured, when pushed, to switch the pressure-sensing unit between a mode for generating the pointer movement signal and a mode for generating the screen scroll signal.

The push button is arranged on one of an upper surface of the mouse body, an undersurface of the mouse body, an upper surface of the housing, and one surface of the housing to correspond to the undersurface of the mouse body.

The pressure-sensing unit is configured to repetitively switch between a mode for generating a pointer movement signal and a mode for generating a screen scroll signal, according to the frequency with which the push button is pushed within a predetermined time, the length of time that the push button is pushed for, or the strength with which the push button is pushed.

The pressure-sensing unit is configured to repetitively switch between a mode for generating a pointer movement signal, a mode for generating a screen scroll signal, and a mode for generating a pointer movement signal in a state of being clicked according to the frequency with which the push button is pushed within a predetermined time, the length of time for which the push button is pushed, or the strength with which the push button is pushed.

The push button is configured such that when the push button is pushed while a pointer is located at a position of an execution button, an execution icon, or a website link, which is displayed on a screen, a drive signal to drive a corresponding drive engine linked with the position is generated.

The pressure-sensing unit is configured to change the screen scroll speed according to the magnitude of the external force that is applied.

The pressure-sensing unit is configured to change the pointer movement speed and the screen scroll speed according to the magnitude of the external force that is applied.

The pressure-sensing unit includes a direction-sensing section configured to sense the direction of the external force applied to the mouse body and to generate a screen scroll-direction signal, and a speed-sensing section configured to sense the magnitude of the external force applied to the mouse body and to generate a screen scroll-speed signal.

The pressure-sensing unit includes a direction-sensing section configured to sense the direction of the external force applied to the mouse body and to generate a pointer movement-direction signal and a screen scroll-direction signal, and a speed-sensing section configured to sense the magnitude of the external force applied to the mouse body and to generate a pointer movement-speed signal and a screen scroll-speed signal.

The housing is provided with a seating groove, the mouse body is entirely or partially fitted into the seating groove, and the direction-sensing section is arranged on an outer circumferential surface of the mouse body or an inner circumferential surface of the seating groove such that the direction-sensing section surrounds the outer circumferential surface of the mouse body fitted into the seating groove.

One of the housing and the mouse body is provided with a protrusion bar, the other of the housing and the mouse body is provided with an accommodation hole into which the protrusion bar is introduced, and the direction-sensing section is arranged on an outer circumferential surface of the protrusion bar or an inner circumferential surface of the accommodation hole such that the direction-sensing section surrounds the outer circumferential surface of the protrusion bar.

According to an aspect of the present invention, a scroll mouse includes: a housing; and, a pressure-sensing unit arranged in the housing to sense the direction of an external force that is applied and to generate a screen scroll signal in the direction of the applied external force.

The pressure-sensing unit is configured to sense the direction and magnitude of the applied external force, and if the magnitude of the applied external force is determined to be within one side of a predetermined value, and to generate a pointer movement signal, and if the magnitude of the applied external force is determined to fall on the other side of the predetermined value, and to generate the screen scroll signal.

The pressure-sensing unit is configured to sense the direction and magnitude of the applied external force and to generate a pointer movement signal in the direction of the applied external force, and after the external force of the magnitude within a predetermined range has been applied with a predetermined frequency or for a predetermined length of time, and to generate the screen scroll signal in the direction of the applied external force.

The pressure-sensing unit is configured to repetitively switch between a mode for moving a pointer and a mode for scrolling a screen, according to the frequency of application of the external force of the magnitude within the predetermined range within a predetermined time, or according to the length of the time of application of the external force of the magnitude for the predetermined range.

The pressure-sensing unit is configured to repetitively switch between a mode for moving a pointer, a mode for scrolling a screen, and a mode for moving a pointer in a state of being clicked, according to the frequency of application of the external force of the magnitude within the predetermined range within a predetermined time, or the length of time of application of the external force of the magnitude within the predetermined range.

According to an aspect of the present invention, a scroll mouse includes: a housing; and a pressure-sensing unit arranged in the housing to sense an external force applied to a position, which is located away from a reference position, and to generate a screen scroll signal in the direction progressing from the reference position towards the position to which the external force is applied.

The pressure-sensing unit is configured to sense the external force applied to the position that is located away from the reference position, and to generate a pointer movement signal in the direction progressing from the reference position towards the position to which the external force is applied, and after the external force of the magnitude within a predetermined range has been applied with a predetermined frequency or for a predetermined length of time, and to generate the screen scroll signal in the direction of the applied external force.

The pressure-sensing unit is configured to repetitively switch between a mode for moving a pointer and a mode for scrolling a screen, according to the frequency with which the external force of the magnitude within the predetermined range is applied within the predetermined time, or the length of time of application of the external force of the magnitude within the predetermined range.

The pressure-sensing unit is configured to repetitively switch between a mode for moving a pointer, a mode for scrolling a screen, and a mode for moving a pointer in a state of being clicked, according to the frequency of application of the external force of the magnitude within the predetermined range within a predetermined time, or the length of time for which the external force of the magnitude within the predetermined range is applied.

According to an aspect of the present invention, a scroll mouse includes: a housing; a pressure-sensing unit arranged in the housing to sense the direction and magnitude of an external force that is applied and to generate a pointer movement signal or a screen scroll signal in the direction of the applied external force; and a push button configured, when pushed, to switch the pressure-sensing unit between a mode for generating the pointer movement signal and a mode for generating the screen scroll signal.

The pressure-sensing unit is configured to repetitively switch between the mode for generating the pointer movement signal and the mode for generating the screen scroll signal, according to the frequency with which the push button is pushed within a predetermined time, the length of time for which the push button is pushed, or the strength with which the push button is pushed.

The pressure-sensing unit is configured to repetitively switch between the mode for generating the pointer movement signal, the mode for generating the screen scroll signal, and a mode for generating the pointer movement signal in a state of being clicked according to the frequency with which the push button is pushed within a predetermined time, the length of time for which the push button is pushed, or the strength with which the push button is pushed.

The push button is arranged to either the position between the pressure-sensing unit and the housing, on an upper surface of the pressure-sensing unit, or an upper surface of the housing.

The push button is configured such that when the push button is pushed while a pointer is located at a position of an execution button, an execution icon, or a website link, which is displayed on a screen, a drive signal to drive a corresponding drive engine linked with the position is generated.

The pressure-sensing unit is configured to change the screen scroll speed according to the magnitude of the external force that is applied.

The pressure-sensing unit is configured to change the pointer movement speed and the screen scroll speed according to the magnitude of the external force that is applied.

The pressure-sensing unit includes a direction-sensing section configured to sense the direction of the external force applied to the mouse body and to generate a screen scroll-direction signal, and a speed-sensing section configured to sense the magnitude of the external force applied to the mouse body and to generate a screen scroll-speed signal.

The pressure-sensing unit includes a direction-sensing section configured to sense the direction of the external force applied to the mouse body and to generate a pointer movement-direction signal and a screen scroll-direction signal, and a speed-sensing section configured to sense the magnitude of the external force applied to the mouse body and to generate a pointer movement-speed signal and a screen scroll-speed signal.

As set forth above, the scroll mouse of the present invention can move a pointer to a distance without significantly moving the mouse body, can freely scroll a screen in various directions, and can easily implement various operations such as dragging, line-drawing, etc.

### BRIEF DESCRIPTION OF THE DRAWINGS

FIGS. 1 and 2 respectively are an exploded perspective view and a cross-sectional view showing a scroll mouse according to one embodiment of the present invention.

FIG. 3 is a view showing the state of the scroll mouse being used.

FIGS. 4 and 5 respectively are an exploded perspective view and a cross-sectional view showing a scroll mouse additionally including a push button according to a second embodiment of the present invention.

FIGS. 6 and 7 are exploded perspective views showing scroll mice in which the position of a push button changes according to third and fourth embodiments of the present invention.

FIG. 8 is a cross-sectional view showing a scroll mouse according to a fifth embodiment of the present invention.

FIG. 9 is a cross-sectional view showing a scroll mouse according to a sixth embodiment of the present invention.

FIG. 10 is an exploded perspective view showing a scroll mouse according to a seventh embodiment of the present invention.

FIGS. 11 and 12 are views showing the state in which the scroll mouse according to the seventh embodiment of the present invention is being used.

FIG. 13 is an exploded perspective view showing a scroll mouse according to an eighth embodiment of the present invention.

FIGS. 14 and 15 are exploded perspective views showing scroll mice in which the position of a push button changes according to ninth and tenth embodiments of the present invention.

### DETAILED DESCRIPTION

A description will now be made in detail of exemplary embodiments of the present invention with reference to the accompanying drawings.

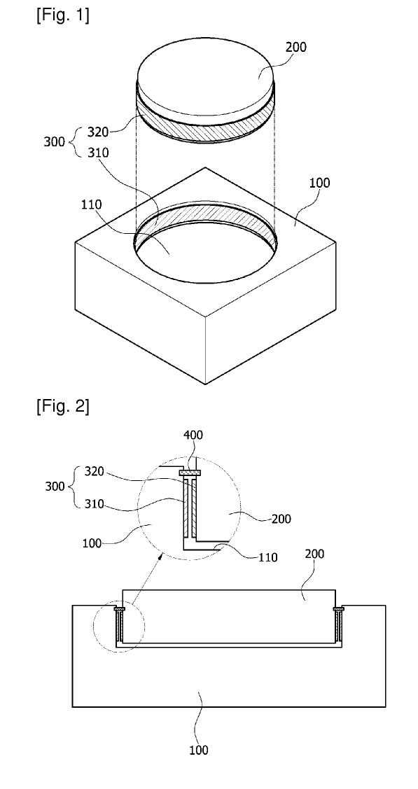

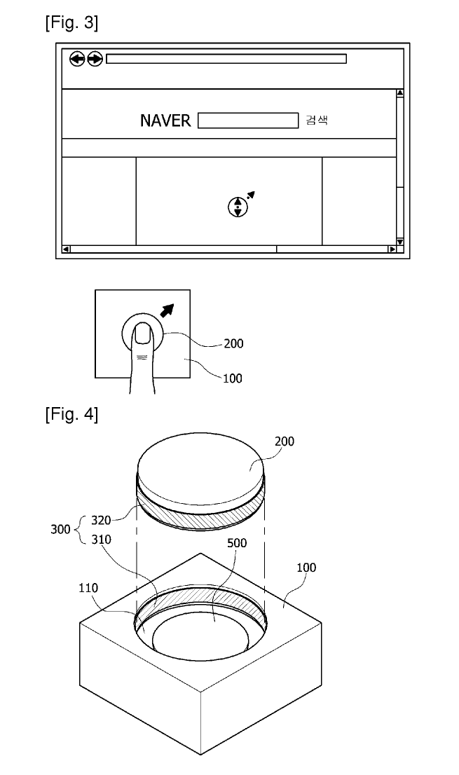

FIGS. 1 and 2 respectively are an exploded perspective view and a cross-sectional view showing a scroll mouse according to one embodiment of the present invention, and FIG. 3 is a view showing the state of the scroll mouse being used.

As shown in FIGS. 1 and 2, the scroll mouse of the illustrated embodiment of includes a housing 100 having a seating groove 110, a mouse body 200 which entirely or partially enters the seating groove 110, and a pressure-sensing unit 300 which is arranged between the housing 100 and the mouse body 200, i.e. between an outer circumferential surface of the mouse body 200, which is inserted into the seating groove 110, and an inner circumferential surface of the seating groove 110, so as to generate a screen scroll signal in the direction of an external force applied to the mouse body 200, according to the magnitude of the external force applied to the mouse body 200.

In the illustrated embodiment, the pressure-sensing unit 300 includes a direction-sensing section 310 designed to sense the direction of the external force applied to the mouse body 200 so as to determine the scroll direction of a screen, and a speed-sensing section 320 designed to sense the magnitude of the external force applied to the mouse body 200 so as to determine the scroll speed of a screen. However, the pressure-sensing unit 300 may be implemented as a single sensing unit that is able to function as the direction-sensing section 310 as well as the speed-sensing section 320. For reference, in a case where the direction-sensing section 310 and the speed-sensing section 320 are separately provided, if either one fails, only the failed section can be replaced by another, making maintenance easier. Further, since the positions of the direction-sensing section 310 and the speed-sensing section 320 can be freely selected, the degree of freedom in designing a product advantageously increases.

In addition, the distraction-sensing section 310 and the speed-sensing section 320 may be formed of touch sensor type elements as shown in the illustrated embodiment, or otherwise may be formed of switch type elements such that they are attached to an outer circumferential surface of the mouse body 200 and an inner circumferential surface of the seating groove 110. That is to say, the distraction-sensing section and the speed-sensing section may be formed of any construction, so long as it can measure the movement direction of the mouse body 200 and the magnitude of the movement force.

Thus, when a user pushes the mouse body 200 towards the lateral direction so as to induce contact pressure between the direction-sensing section 310 and the speed-sensing section, the direction-sensing section 310 generates a screen scroll signal in the direction of an external force that is applied. Here, the pressure-sensing unit 300 is mounted to the mouse body such that it surrounds the entire outer circumferential surface of a lower portion of the mouse body 200 which is introduced into the seating groove 110, so that to be used, the scroll mouse of the illustrated embodiment can scroll a screen in the vertical, horizontal, and even diagonal directions. The technique of scrolling a screen in various directions has already been known and commercialized, so its detailed description will be omitted.

In addition, the speed-sensing section 320 serves to regulate the scroll speed of a screen according to the magnitude of an external force applied to the mouse body 200. For example, the speed-sensing section 320 generates a low-speed scroll signal to scroll the screen slowly if a relatively small external force is applied to the mouse body 200. In addition, the speed-sensing section 320 also generates a high-speed scroll signal to scroll the screen rapidly if a relatively large external force is applied to the mouse body 200. Thus, a user can freely regulate the scroll speed of a screen by regulating the force applied to the mouse body 200.

Further, the scroll mouse according to one embodiment may be configured to additionally perform a pointer movement function, as well as the screen scroll function.

That is, the pressure-sensing unit 300 may be configured such that if the magnitude of the external force applied to the mouse body 200 is determined to be within one side of a predetermined value, it generates a pointer movement signal in the direction of the external force applied to the mouse body 200, and if the magnitude of the external force applied to the mouse body 200 is determined to be within the other side of the predetermined value, it generates a screen scroll signal in the direction of the external force applied to the mouse body 200. For example, the scroll mouse may be configured to move a pointer if the force with which a user pushes the mouse body 200 is less than the predetermined value, and to scroll a screen if the force with which the user pushes the mouse body 200 is larger than the predetermined value. Of course, the scroll mouse may also be configured in a reverse operation mode such that it scrolls a screen if the force with which the user pushes the mouse body 200 is less than the predetermined value, and it moves the pointer if the same force is above the predetermined value.

Here, the operation of the scroll mouse according to an embodiment will be described in more detail with reference to the case where the scroll mouse generates the pointer movement signal when the external force applied to the mouse body 200 is below the predetermined value, and generates the screen scroll signal when the external force applied to the mouse body 200 is above the predetermined value.

First, when a user pushes the mouse body 200 with an external force below the predetermined value so that only a relatively small contact pressure is applied between the direction-sensing section 310 and the speed-sensing section 320, the direction-sensing section 310 generates a pointer movement direction signal in the direction of the applied external force to move a pointer displayed on a screen. Here, when the force with which user pushes the mouse body 200 is much smaller than the predetermined value, the speed-sensing section 320 generates a low-speed pointer movement signal to move a pointer slowly, and when the user pushes the mouse body 200 with a relatively large force similar to the predetermined value, the speed-sensing section 320 generates a high-speed pointer movement signal to move a pointer rapidly.

On the contrary, when a user pushes the mouse body 200 with an external force much stronger than a predetermined value so as to apply a relatively large contact pressure between the direction-sensing section 310 and the speed-sensing section 320, the direction-sensing section 310 generates a screen scroll direction signal so that the screen is scrolled in the direction of the applied external force. Here, when the user pushes the mouse body 200 with a force slightly larger than the predetermined value, the speed-sensing section 320 generates a low-speed screen scroll signal so as to scroll a screen slowly, and when the user pushes the mouse body 200 with a force much larger than the predetermined value, the speed-sensing section 320 generates a high-speed screen scroll signal so as to scroll a screen rapidly.

Like this, according to the scroll mouse of one embodiment of the present invention, a user can move a pointer and scroll a screen by regulating the force with which the mouse body 200 is pushed in the lateral direction, advantageously making it easier to search long documents or surf the Internet.

Meanwhile, the predetermined value of the external force applied to the mouse body 200 that is the criterion on which the pressure-sensing unit 300 generates the pointer movement signal or the screen scroll signal may be set properly and initially in the pressure-sensing unit, or otherwise may be set such that a user can adjust it to suit his own situation.

In addition, in the state where a user pushes the mouse body 200 in one direction to bring the direction-sensing section 310 and the speed-sensing section 320 into contact with each other, if even when the user releases his hold of the mouse body 200, the direction-sensing section 310 and the speed-sensing section 320 still stay in a state of contact, there may be a possibility that a pointer continuously moves, or a screen is continuously scrolled, even without the user pushing the mouse body 200 in one direction.

Thus, the scroll mouse of an embodiment of the invention includes an elastic member 400 one side of which is coupled to an inner wall of the seating groove 110 and the other side of which is coupled to the mouse body 200. The elastic member serves to position the mouse body 200 at the center of the seating groove 110 and thereby position the mouse body at its original position such that pressure is not applied to both the direction-sensing section 310 and the speed-sensing section 320, so long as a separate external force is not applied to the mouse body 200. The elastic member 400 may be made of an elastic material such as a sponge or an elastic synthetic resin, or otherwise may be made from a spring member such as a coil spring or a leaf spring.

While FIGS. 1 and 2 only illustrate a direction-sensing section 310 and a speed-sensing section 320 that are initially separated from each other and that come into contact with each other when the mouse body 200 moves, the direction-sensing section 310 and the speed-sensing section 320 may be provided such that they are initially in contact with each other. In this case, the direction-sensing section 310 is configured to generate a pointer movement signal or a screen scroll signal when a user applies an external force to the mouse body 200 in the horizontal direction. In addition, the speed-sensing section 320 is designed to generate a pointer speed variation signal or a scroll speed variation signal according to the variation in the magnitude of the applied external force.

If the direction-sensing section 310 and the speed-sensing section 320 are configured such that they are in continuous contact with each other, contact noise occurring when the direction-sensing section 310 and the speed-sensing section 320 that are in a state of separation are brought into contact with each other is prevented, and considerable agitation of the mouse body 200 is also prevented, thereby improving manipulation of the mouse body 200 and effectively preventing dust or foreign substances from being introduced between the direction-sensing section 310 and the speed-sensing section 320.

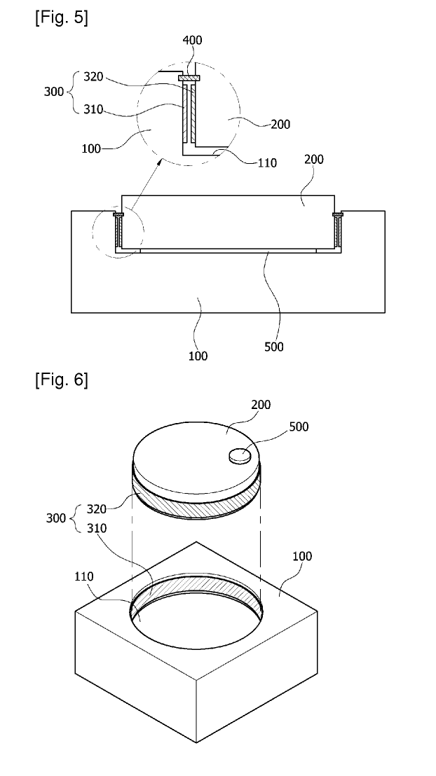

FIGS. 4 and 5 respectively are an exploded perspective view and a cross-sectional view showing a scroll mouse additionally including a push button 500 according to another embodiment of the present invention.

The fixed type housing of one embodiment of the present invention may be further provided with the push button 500 which is designed, when pushed, to switch the pressure-sensing unit 300 between a mode for generating a pointer movement signal and a mode for generating a screen scroll signal. That is, the pressure-sensing unit 300 may be configured to generate the pointer movement signal or the screen scroll signal according to whether the push button 500 is pushed or not, rather than by detecting the magnitude of an external force applied to the mouse body 200.

For example, it may be configured such that when the mouse body 200 is pushed in the lateral direction while the push button 500 is not pushed in the state shown in FIG. 5, a pointer is moved, and when the mouse body 200 is pushed down in the state shown in FIG. 5 to push the push button 500, a screen is scrolled when the mouse body 200 is pushed in the lateral side.

In the embodiments shown in FIGS. 1 to 3, if a user fails to correctly regulate the force applied to the mouse body 200, there is a risk of scrolling a screen even though the user intends to move a pointer, and vice versa. However, if the push button 500 is further provided as illustrated in the embodiments of FIGS. 4 and 5, advantageously, the pointer movement or screen scroll can be surely and separately implemented irrespective of the magnitude of the force applied by a user to the mouse body 200.

Here, the pressure-sensing unit 300 may be configured to switch between a mode for generating a pointer movement signal and a mode for generating a screen scroll signal according to the frequency with which the push button 500 is pushed within a predetermined time, the length of time for which the push button 500 is pushed, or the strength with which the push button 500 is pushed. That is, the pressure-sensing unit may be configured such that if the push button 500 is pushed once, it switches to screen scroll mode, and if the push button 400 is pushed once more, it switches from screen scroll mode to pointer movement mode. In addition, the pressure-sensing unit may also be configured such that if the push button is pushed for a long time, it alternately switches between screen scroll mode and pointer movement mode as time passes. Furthermore, the pressure-sensing unit may also be configured such that if the push button 500 is strongly pushed, it switches to screen scroll mode, and if the push button is softly pushed, it switches from screen scroll mode to pointer movement mode.

In addition, a task using a mouse generally includes a mouse movement action that is performed in a state of being mouse-clicked, such as dragging, line-drawing, etc., in addition to the above-mentioned pointer movement action and screen scroll action. Thus, the pressure-sensing unit 300 may be configured to switch between a mode for generating a pointer movement signal, a mode for generating a screen scroll signal, and a mode for generating a pointer movement signal in a state of being clicked according to the frequency with which the push button 500 is pushed within a predetermined time, the length of time for which the push button 500 is pushed, or the strength with which the push button 500 is pushed. If the scroll mouse is configured as such, a user can advantageously perform even a task, such as dragging, line-drawing, etc., that can only be implemented by moving the mouse in a clicked state.

In addition, the push button 500 may also be changed to a functional button (a so-called click button) provided in a conventional mouse. That is, the scroll mouse according to one embodiment of the present invention may be configured such that when the push button 500 is pushed while a pointer is located above a position where an execution button is located (e.g. a ‘search’ button, a ‘GO’ button, etc. displayed on a website or by a web browser), an execution icon, or a website link, which is displayed on a screen, a drive signal is generated to drive a corresponding drive engine linked with the position (i.e. where the execution button, the execution icon, or the website exists).

Such an algorithm in which when a button mounted in a mouse is pushed, an execution button where a pointer is located is selected so as to drive a drive engine linked therewith, has already been known and commercialized, and so a detailed description thereof will be omitted.

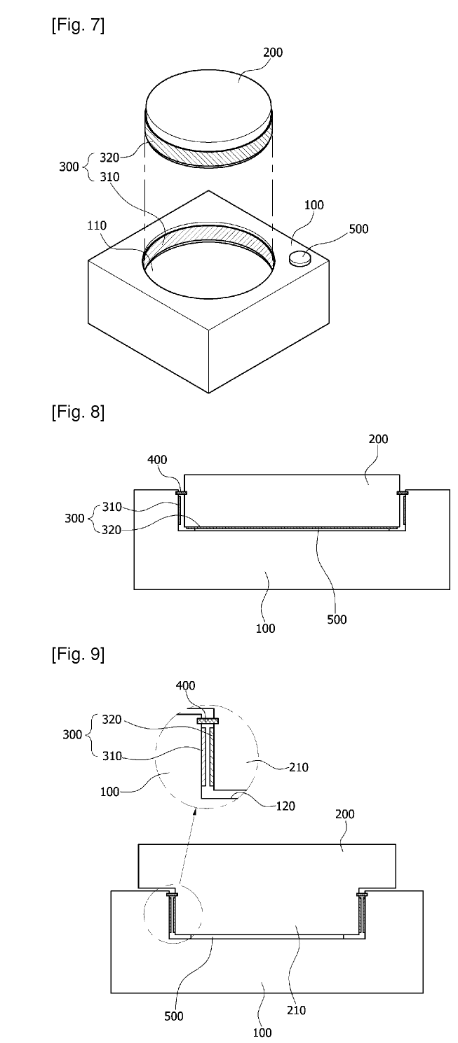

FIGS. 6 and 7 are exploded perspective views showing scroll mice in which the position of a push button 500 changes according to additional embodiments of the present invention.

The push button 500 provided in the scroll mouse of one embodiment of the present invention may be arranged on the bottom of the seating groove 110, an undersurface of the mouse body 200 to correspond to the bottom of the seating groove 110 (as shown in FIGS. 4 and 5), an upper surface of the mouse body 200 (as shown in FIG. 6), or an upper surface of the housing 100 (as shown in FIG. 7). That is, the push button 500 may be arranged in various places to suit the user's convenience.

When the push button 500 is provided on the bottom of the seating groove 110 or the undersurface of the mouse body 200 as shown in FIGS. 4 and 5, there may be a risk that when the mouse body 200 is being moved in the lateral direction, the mouse body 200 moves down and unintentionally pushes the push button 500. However, if the push button 500 is provided on the upper surface of the mouse body 200 as shown in FIG. 6, it is advantageous because even when the mouse body 200 is being moved in the lateral direction, the push button 500 is prevented from being unintentionally pushed.

In addition, when the push button 500 is provided on the upper surface of the housing 100 as shown in FIG. 7, it is advantageous that a user can manipulate the mouse body 200 and the push button 500, respectively using his index finger and middle finger, thereby performing various tasks using a mouse in a faster, easier manner.

FIG. 8 is a cross-sectional view showing a scroll mouse according to another embodiment of the present invention, and FIG. 9 is a cross-sectional view showing a scroll mouse according to yet another embodiment of the present invention.

Generally, when a user pushes the mouse body 200 with his finger, he pushes it not in the horizontal direction, but at an incline of e.g. approximately 45 degrees, so that the force applied by the user consists of a horizontal component and a vertical component.

Here, the direction-sensing section 310 included in the scroll mouse according to one embodiment of the present invention serves to sense the horizontal component of the force applied by the user, so that it is preferably mounted such that it surrounds the inner circumferential surface of the seating groove 110. However, the speed-sensing section 320 can detect the magnitude of the force with which a user pushes the mouse body 200 even when it senses the vertical component of the force. Thus, the speed-sensing section 320 may be mounted on the undersurface of the mouse body 200 as shown in FIG. 8.

Like this, if the direction-sensing section 310 and the speed-sensing section 320 are completely separated, it is advantageous for the installation and maintenance thereof and makes these easy, and the possibility of contact damage being done to the direction-sensing section 310 and the speed-sensing section 320 can be reduced.

In addition, in the scroll mouse of an embodiment may be configured such that one of the housing 100 and the mouse body 200 is provided with a protrusion bar 210, the other of the housing 100 and the mouse body 200 is provided with an accommodation hole 120 into which the protrusion bar 210 is introduced, and the direction-sensing section 310 is arranged on an outer circumferential surface of the protrusion bar 210 or an inner circumferential surface of the accommodation hole 120 such that the direction-sensing section surrounds the outer circumferential surface of the protrusion bar 210.

The scroll mouse of the embodiment shown in FIG. 9 is configured such that the direction-sensing section 310 and the speed-sensing section 320 are mounted not on the outer surface of the mouse body 200, but on the protrusion bar 210, so that the scroll mouse has a characteristic in that the external shape of the mouse body 200 can be freely formed.

That is, in case of the embodiments shown in FIGS. 1 to 8, since the direction-sensing section 310 is mounted such that it surrounds an outer wall of the mouse body 200 or an inner wall of the seating groove 110, the direction-sensing section 310 should have the form of a ring and the mouse body 200 should also have the planar shape of a circle, in order to apply a force of the same magnitude to the direction-sensing section in all directions, thereby causing a problem in that it is inconvenient for the hand of a user to hold the mouse body 200. However, if the direction-sensing section 310 is configured such that it is mounted between the protrusion bar 210 and the accommodation hole 120, since only the protrusion bar 210 and the accommodation hole 120 are required to be of a cylindrical shape, there is no restriction in the shape of the mouse body 200. That is, in case of the embodiment shown in FIG. 9, the mouse body 200 may be formed in an ergonomic and aerodynamic shape like a conventional mouse, to provide the advantage of allowing a user to become accustomed to using the mouse without a user rejecting the mouse.

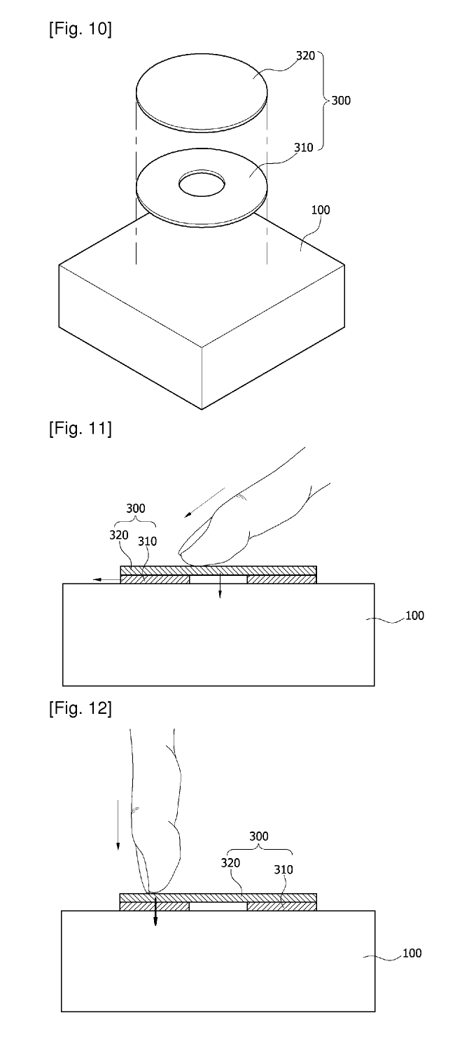

FIG. 10 is an exploded perspective view showing a scroll mouse according to another embodiment of the present invention, and FIGS. 11 and 12 are views showing the state in which the scroll mouse according to the embodiment of FIG. 10 is being used.

The scroll mouse according to one embodiment of the present invention may be configured to only include a housing 100 and a pressure-sensing unit 300, without the mouse body 200 as shown in FIGS. 1 to 9.

That is, as shown in FIGS. 10 to 12, the scroll mouse may include the housing 100, and the pressure-sensing unit 300 which is mounted in the housing 100 and is designed to sense the direction and magnitude of an external force that is applied and to generate a pointer movement signal or a screen scroll signal in the direction of the applied external force according to the magnitude of the applied external force.

Here, the pressure-sensing unit 300 includes a direction-sensing section 310 and a speed-sensing section 320. The direction-sensing section 310 serves to sense the direction of the external force applied in the lateral direction and to generate a pointer movement direction signal and a screen scroll direction signal. The speed-sensing section 320 serves to sense the magnitude of the external force applied in the vertical direction and to generate a pointer movement speed signal and a screen scroll speed signal. The direction-sensing section 310 and the speed-sensing section 320 may be formed in the form of a touch pad, so that they can be mounted on the upper surface of the housing 100 in a layered manner. In addition, the pressure-sensing unit 300 may be formed like a single touch sensor unit that can implement both the function of the direction-sensing section 310 and the function of the speed-sensing section 320.

When a user pushes the direction-sensing section 310 and the speed-sensing section 320 using his finger as shown in FIG. 11, the finger force is generally exerted at an angle, so that the force applied to the direction-sensing section 310 and the speed-sensing section 320 can be decomposed into a horizontal component and a vertical component. Here, the direction-sensing section 310 senses the horizontal component force and to generate a pointer movement direction signal and a screen scroll direction signal, and the speed-sensing section 320 senses the vertical component force to so as to generate a pointer movement speed signal and a screen scroll speed signal. Such a touch pad is designed to sense the direction and magnitude of the applied force and has been widely adapted to diverse kinds of mobile communication terminals or portable electronic appliances, so that the detailed description will be omitted.

In the meantime, while the present embodiment has only illustrated the speed-sensing section 320 as being mounted in the upper side of the direction-sensing section 310, the position of the direction-sensing section 310 and the speed-sensing section 320 may be reversed. That is, the speed-sensing section 320 may be first mounted on the upper surface of the housing 100, and the direction-sensing section 310 may then be mounted thereon. Further, if needed, the pressure-sensing unit 300 may be formed as a single touch sensor unit in which the direction-sensing section 310 and the speed-sensing section 320 are integrated.

In the meantime, the pressure-sensing unit 300 may also be configured such that it senses the direction and magnitude of the applied external force so as to generate a pointer movement signal in the direction of the applied external force, and after the external force of the magnitude within a predetermined range has been applied with a predetermined frequency or for a predetermined length of time, a screen scroll signal is generated in the direction of the applied external force.

Like this, if it is configured such that the pressure-sensing unit 300 generates a screen scroll signal after an external force of the magnitude within a predetermined value has been applied under specific conditions, it is advantageous for implementing pointer movement and screen scroll in a state of these being more definitely separated.

In addition, it is preferred that the direction-sensing section 310 and the speed-sensing section 320 be formed in a disc shape in order to uniformly receive the force even though a user applies the force in various directions. Here, the direction-sensing section 310 may be formed in the shape of a ring with a central hole, such that when a user contacts the center portion of a speed-sensing section 320 with his finger, the direction-sensing section 310 does not generate a pointer movement direction signal or a screen scroll direction signal.

In addition, the direction-sensing section 310 may be configured such that when an external force is applied to a position separated apart from a reference position (e.g. a center point of the central hole) as shown in FIG. 12, it generates a pointer movement direction signal or a screen scroll direction signal to move a pointer or scroll a screen in the direction progressing from the reference position towards the position to which the external force is applied. Here, similar to the embodiments shown in FIGS. 10 and 11, the speed-sensing section 320 is configured to sense the magnitude of the external force applied and to generate a pointer movement speed signal or a screen scroll speed signal.

If configured as such, the pointer movement direction and speed or the screen scroll direction and speed can be set at once just by sensing the force vertically applied to the ring type direction-sensing section 310 at a specific position relative to the central hole as a reference position, without sensing the external force in the horizontal direction. Thus, there is the advantage of a user being able to move a pointer or scroll a screen at the desired speed only by performing the action of applying a vertical force at a spaced-apart position in the desired direction, without a need to separately apply the vertical force and horizontal force, respectively, to the position where the direction-sensing section 310 and the speed-sensing section 320 are on top of one another, or to apply an external force at an angle of inclination in one direction.

In addition, the pressure-sensing unit 300 may be configured such that it senses an external force applied to a position separated apart from a reference position so as to generate a pointer movement signal to move a pointer in the direction progressing from the reference position towards the position where the external force is applied, and after the external force of the magnitude within a predetermined value has been applied with a predetermined frequency or for a predetermined length of time, generate a screen scroll signal to scroll a screen in the direction of the applied external force.

Also in case of the embodiments shown in FIGS. 10 to 12, similar to the embodiments shown in FIGS. 4 and 5, the pressure-sensing unit 300 may be configured such that it switches between a mode for moving a pointer and a mode for scrolling a screen, or between a mode for moving a pointer, a mode for scrolling a screen, and a mode for moving a pointer in a state of being clicked, according to the frequency with which an external force of a magnitude within a predetermined value is applied within a predetermined time, or the length of time of application of an external force of a magnitude within a predetermined value. The advantages obtained from the configuration in which the pressure-sensing unit 300 switches between the above-mentioned modes were described with reference to FIGS. 4 and 5, so the detailed description will be omitted.

While the embodiments shown in FIGS. 10 to 12 selectively implement either one of pointer movement and screen scroll according to the force applied to the pressure-sensing unit 300 by a user, the scroll mouse may be configured such that although it has the same structure shown in FIGS. 10 to 12, the pressure-sensing unit 300 only generates a screen scroll signal. Of course, even though the scroll mouse in one embodiment of the invention is only designed to scroll a screen, the scroll mouse may also be configured such that the direction-sensing section 310 generates a screen scroll direction signal, and the speed-sensing section 320 generates a screen scroll speed signal, thereby allowing a screen to be scrolled slowly or rapidly.

In such a configuration in which the scroll mouse can only perform screen-scrolling, the operation of the pressure-sensing unit 300 was described with reference to the embodiments shown in FIGS. 1 to 3, so the detailed description will be omitted.

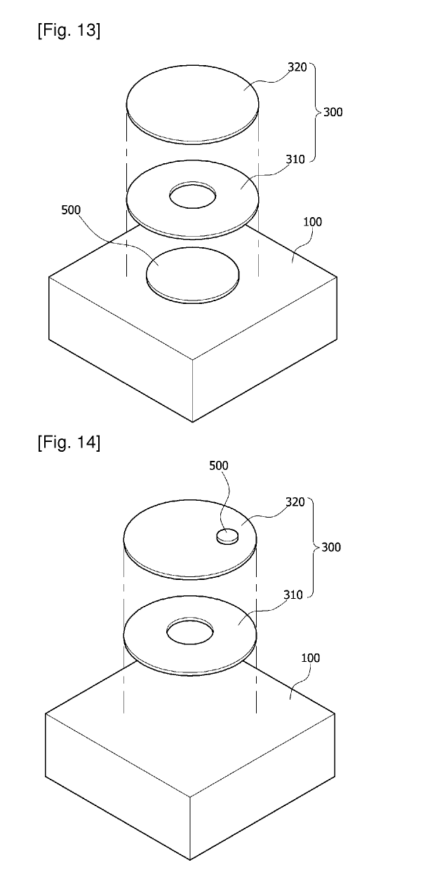

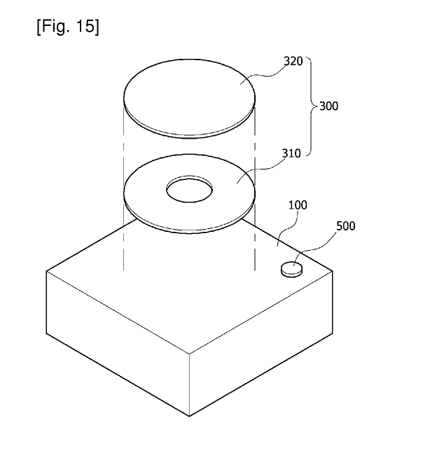

FIG. 13 is an exploded perspective view showing a scroll mouse according to another embodiment of the present invention, and FIGS. 14 and 15 are exploded perspective views showing scroll mice in which the position of a push button 500 changes according to yet another embodiment of the present invention.

The scroll mouse according to one embodiment of the invention, which basically only includes the housing 100 and the pressure-sensing unit 300, may further include the push button 500, which is configured such that when pushed by a user as shown in FIGS. 4 and 5, it switches the pressure-sensing unit 300 between a mode for generating a pointer movement signal and a mode for generating a screen scroll signal.

The push button 500 may be provided between the undersurface of the pressure-sensing unit 300 and the upper surface of the housing 100 (as shown in FIG. 13), on the upper surface of the pressure-sensing unit 300 (as shown in FIG. 14), or on the upper surface of the housing 100 (as shown in FIG. 15).

The advantages according to the positions of the push button 500 were described in detail with reference to FIGS. 6 and 7, so the detailed description will be omitted.

Although preferred embodiments of the present invention have been described heretofore, the scope of the present invention is not limited to the specified embodiments, but should be construed by the accompanying claims. Those skilled in the art will appreciate that various modifications, additions and substitutions are possible, without departing from the scope and spirit of the invention.

1.-20. (canceled)

21. A scroll mouse comprising:
a housing;
a mouse body arranged in the housing; and
a pressure-sensing unit configured to sense a direction of an external force that is applied to the mouse body and to generate a screen scroll signal in the direction of the external force applied to the mouse body.

22. The scroll mouse according to claim 21, wherein the pressure-sensing unit is configured to sense the direction and a magnitude of the external force applied to the mouse body, and if the magnitude of the external force applied to the mouse body is determined to be within one side of a predetermined value, and to generate a pointer movement signal, and if the magnitude of the external force applied to the mouse body is determined to be within the other side of the predetermined value, and to generate the screen scroll signal in the direction of the external force applied to the mouse body.

23. The scroll mouse according to claim 21, wherein the pressure-sensing unit is configured to sense the direction and a magnitude of the external force applied to the mouse body and to generate a pointer movement signal in the direction of the external force applied to the mouse body, and after the external force of the magnitude within a predetermined range has been applied to the mouse body with a predetermined frequency or for a predetermined length of time, to generate the screen scroll signal in the direction of the external force applied to the mouse body.

24. The scroll mouse according to claim 21, wherein the pressure-sensing unit is configured to sense the direction and a magnitude of the external force applied to the mouse body and to generate a pointer movement signal or the screen scroll signal in the direction of the external force applied to the mouse body, and the scroll mouse further includes a push button configured, when pushed, to switch the pressure-sensing unit between a mode for generating the pointer movement signal and a mode for generating the screen scroll signal.

25. The scroll mouse according to claim 24, wherein the push button is arranged on either one of an upper surface of the mouse body, an undersurface of the mouse body, an upper surface of the housing, and one surface of the housing that corresponds to the undersurface of the mouse body.

26. The scroll mouse according to claim 21, wherein the pressure-sensing unit is configured to change a screen scroll speed according to the magnitude of the external force that is applied.

27. The scroll mouse according to claim 22, wherein the pressure-sensing unit is configured to change a pointer movement speed and a screen scroll speed according to the magnitude of the external force that is applied.

28. The scroll mouse according to claim 23, wherein the pressure-sensing unit is configured to change a pointer movement speed and a screen scroll speed according to the magnitude of the external force that is applied.

29. The scroll mouse according to claim 21, wherein the pressure-sensing unit includes a direction-sensing section configured to sense the direction of the external force applied to the mouse body and to generate a screen scroll-direction signal, and a speed-sensing section configured to sense the magnitude of the external force applied to the mouse body and to generate a screen scroll-speed signal.

30. The scroll mouse according to claim 21, wherein the housing is provided with a seating groove, the mouse body is entirely or partially fitted into the seating groove, and the direction-sensing section is arranged on an outer circumferential surface of the mouse body or an inner circumferential surface of the seating groove such that the direction-sensing section surrounds the outer circumferential surface of the mouse body fitted into the seating groove.

31. The scroll mouse according to claim 21, wherein one of the housing and the mouse body is provided with a protrusion bar, the other of the housing and the mouse body is provided with an accommodation hole into which the protrusion bar is introduced, and the direction-sensing section is arranged on an outer circumferential surface of the protrusion bar or an inner circumferential surface of the accommodation hole such that the direction-sensing section surrounds the outer circumferential surface of the protrusion bar.

32. A scroll mouse comprising:
a housing; and
a pressure-sensing unit arranged in the housing to sense a direction of an external force that is applied and to generate a screen scroll signal in the direction of the applied external force.

33. The scroll mouse according to claim 32, wherein the pressure-sensing unit is configured to sense the direction and a magnitude of the applied external force, and if the magnitude of the applied external force is determined to be within one side of a predetermined value, and to generate a pointer movement signal, and if the magnitude of the applied external force is determined to be within the other side of the predetermined value, and to generate the screen scroll signal.

34. The scroll mouse according to claim 32, wherein the pressure-sensing unit is configured to sense the direction and a magnitude of the applied external force and to generate a pointer movement signal in the direction of the applied external force, and after the external force of the magnitude within a predetermined range has been applied with a predetermined frequency or for a predetermined length of time, and to generate the screen scroll signal in the direction of the applied external force.

35. A scroll mouse comprising:
a housing; and
a pressure-sensing unit arranged in the housing to sense an external force applied to a position separated apart from a reference position to a screen scroll signal in the direction progressing from the reference position towards the position to which the external force is applied.

36. The scroll mouse according to claim 35, wherein the pressure-sensing unit is configured to sense the external force applied to the position separated from the reference position and to generate a pointer movement signal in the direction progressing from the reference position towards the position to which the external force is applied, and after the external force of the magnitude within a predetermined range has been applied with a predetermined frequency or for a predetermined length of time, and to generate the screen scroll signal in the direction of the applied external force.

37. A scroll mouse comprising:
a housing;
a pressure-sensing unit arranged in the housing to sense a direction and a magnitude of an external force that is applied and to generate a pointer movement signal or a screen scroll signal in the direction of the applied external force; and
a push button configured, when pushed, to switch the pressure-sensing unit between a mode for generating the pointer movement signal and a mode for generating the screen scroll signal.

38. The scroll mouse according to claim 37, wherein the push button is arranged to be between the pressure-sensing unit and the housing, on an upper surface of the pressure-sensing unit, or on an upper surface of the housing.

39. The scroll mouse according to claim 21, wherein the pressure-sensing unit is configured to change a screen scroll speed according to the magnitude of the external force that is applied.

40. The scroll mouse according to claim 32, wherein the pressure-sensing unit is configured to change a screen scroll speed according to the magnitude of the external force that is applied.

41. The scroll mouse according to claim 35, wherein the pressure-sensing unit is configured to change a screen scroll speed according to the magnitude of the external force that is applied.

42. The scroll mouse according to claim 33, wherein the pressure-sensing unit is configured to change a screen scroll speed according to the magnitude of the external force that is applied.

43. The scroll mouse according to claim 32, wherein the pressure-sensing unit is configured to change a pointer movement speed and a screen scroll speed according to the magnitude of the external force that is applied.

44. The scroll mouse according to claim 35, wherein the pressure-sensing unit includes a direction-sensing section configured to sense the direction of the external force applied to the mouse body and to generate a screen scroll-direction signal, and a speed-sensing section configured to sense the magnitude of the external force applied to the mouse body and to generate a screen scroll-speed signal.
